(19) United States
(12) Patent Application Publication
(10) Pub. No.: US 2007/0223386 A1
(43) Pub. Date: Sep. 27, 2007

(54) Monitoring device and system

(75) Inventors: Takanori Yasui, Kawasaki (JP); Hideki Shiono, Kawasaki (JP); Masaki Hiromori, Kawasaki (JP); Hirofumi Fujiyama, Kawasaki (JP); Satoshi Tomie, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/502,550

(22) Filed: Aug. 11, 2006

(30) Foreign Application Priority Data
Mar. 22, 2006 (JP) 2006-079744

(51) Int. Cl. H04J 1/16

(52) U.S. Cl. 370/250

(57) ABSTRACT

In a monitoring device and system, a monitoring data inserter inserts monitoring data of a predetermined pattern into an idle period of input data to be transmitted to a transmission line. A monitoring data checker having received the monitoring data through the transmission line, when determining that the monitoring data does not maintain the predetermined pattern, provides selective switchover instructions to a selector to be controlled. Then, the monitoring data checker sequentially performs a selective switchover to processors, thereby detecting a failure point in the processors. Also, when the failure point in the processors can not be detected, the monitoring data checker provides channel switchover instructions to a switching portion and performs a channel switchover of the transmission line, thereby detecting which channel of the transmission line has caused a failure.

### BACKGROUND OF THE INVENTION

1. Field of the Invention

The present invention relates to a monitoring device and system, and in particular to a monitoring device (or method) and system for detecting a failure in a rewritable device such as an FPGA (Field Programmable Gate Array), an LSI (Large Scale Integration), or a memory mounted on a frame converting device or the like.

2. Description of the Related Art

A frame switching system shown in FIG. 18 is composed of an Ethernet (registered trademark) network 1, frame converting devices 2_1-2_{—}n (hereinafter, occasionally represented by a reference numeral 2) for performing a conversion of an Ethernet frame into a SONET (Synchronous Optical Network)/SDH (Synchronous Digital Hierarchy) frame or a conversion of the SONET/SDH frame into the Ethernet frame, a switching equipment 3 for switching the frame according to destination information within the Ethernet frame or the SONET/SDH frame, and a telephone network 4 using SONET/SDH.

Also, the frame converting devices 2_1-2_{—}n are respectively provided with input/output processors 20_1-20_{—}n (hereinafter, occasionally represented by a reference numeral 20), ingress portions 30_1-30_{—}n (hereinafter, occasionally represented by a reference numeral 30), backboard interfaces 40_1-40_{—}n (hereinafter, occasionally represented by a reference numeral 40), and egress portions 50_1-50_{—}n (hereinafter, occasionally represented by a reference numeral 50).

In this frame switching system shown in FIG. 18, for example, when data DT addressed to the frame converting device 2_{—}n from the Ethernet network 1 is inputted to the frame converting device 2_1, the frame converting device 2_1 converts the data DT into a SONET/SDH frame FR sequentially through the internal input/output processor 20_1, the ingress portion 30_1, and the backboard interface 40_1 to be transmitted to the switching equipment 3.

The switching equipment 3 having received the SONET/SDH frame FR recognizes from the destination information within the SONET/SDH frame FR that the destination is the frame converting device 2_{—}n, and transfers the SONET/SDH frame FR to the frame converting device 2_{—}n.

The frame converting device 2_{—}n having received the the SONET/SDH frame FR converts the SONET/SDH frame FR into the data DT sequentially through the internal backboard interface 40_{—}n, the egress portion 50_{—}n, and the input/output processor 20_{—}n, and transfers the data DT to e.g. a user terminal (not shown) within the Ethernet network 1.

Recently, in the development of the frame converting devices 2 or the like having a plurality of functional blocks such as the above-mentioned input/output processor 20, the ingress portion 30, the backboard interface 40, and the egress portion 50, a procedure has been generally adopted where the FPGAs or the like whose functions can be modified by rewriting logic of programs are used for the functional blocks.

For a monitoring technology of a failure in the FPGA, the following prior art example has been known.

### Prior Art Example: FIG. 19

A monitoring device 10 is shown in FIG. 19, emphasizing the input/output processor 20, the ingress portion 30, and the backboard interface 40 extracted, which form a part of the arrangement of the frame converting devices 2 shown in FIG. 18. Functional blocks are respectively composed by using corresponding FPGAs 100-300. It is to be noted that, in order to simplify FIG. 19, the description of an FPGA 400 corresponding to the egress portion 50 is omitted, where the following description is similarly applied only with the signal flow being reversed.

Also, the FPGA 100 and the FPGA 200, as well as the FPGA 200 and FPGA 300 are respectively connected with transmission lines L1 and L2 which are respectively composed of 32 channels.

The FPGA 100 is composed of a processor 110, for example, for confirming whether or not a format of data D1 inputted is correct, namely, whether or not the format meets the standard of the Ethernet frame, supposing the data D1 is the Ethernet frame, and a parity bit generator 1000_1 for generating a parity bit from output data D2 of the processor 110 to confirm whether or not the transmission line L1 which transmits the output data D2 is properly connected, and transmitting the parity bit to a serial transmission line L1_EXT separately provided in parallel with the transmission line L1.

Also, the FPGA 200 is composed of a processor 210, for example, for monitoring a flow volume of the data D2 (the monitoring result is not shown) having been received from the FPGA 100 through the transmission line L1 and writing the data D2 in a memory MEM for a speed conversion, a processor 220 for reading the data D2 out of the memory MEM according to a priority attached to the destination information within e.g. the data D2, a parity bit checker 1100_1 for checking the parity bit having been received from the above-mentioned parity bit generator 1000_1 through the transmission line L1_EXT, and a parity bit generator 1000_2 for generating a parity bit from output data D3 of the processor 220 to confirm whether or not the transmission line L2 which transmits the output data D3 is properly connected, and transmitting the parity bit to a serial transmission line L2_EXT separately provided in parallel with the transmission line L2.

Also, the FPGA 300 is composed of a processor 310, for example, for converting the data D3 having been received from the FPGA 200 through the transmission line L2 into the SONET/SDH frame, and a parity bit checker 1100_2 for checking the parity bit having been received from the above-mentioned parity bit generator 1000_2 through the transmission line L2_EXT.

Thus, by separately providing the parity bit generators 1000_1 and 1000_2, and the parity bit checkers 1100_1 and 1100_2 to the transmission lines L1 and L2, it becomes possible to respectively and independently detect connection faults of the transmission lines L1 and L2.

In the monitoring device 10, the parity bit checker 1100_1 or 1100_2, as shown by dotted lines in FIG. 19, notifies an error notification ERR to e.g. a managing portion (not shown) or the like when detecting an error in the parity bit, thereby enabling a maintenance person to perform a recovery operation of the transmission line L1 or L2 having caused the failure.

Also, as for a transmission line between the FPGA 400 not shown in the FIG. 19 and the FPGA 100 or 300, in the same way as the above, by separately providing the parity bit generator and the parity bit checker, it becomes possible to detect the connection fault (see e.g. patent document 1).

As a reference example, a monitoring technology can be mentioned that, in a duplicated device being composed of the same functional block groups duplicated and mutually connected with a common bus, one functional block group of the duplicated device accesses the other functional block group for diagnoses, thereby detecting a failure point when a failure has occurred (see e.g. patent document 2).
[Patent document 1] Japanese Patent Application Laid-open No. 2004-151061
[Patent document 2] Japanese Patent Application Laid-open No. 03-037734

In the above-mentioned patent document 1, it is possible to detect that the connection fault has occurred in the transmission line itself by providing the parity bit generator and the parity bit checker per transmission line between the FPGAs to check the parity bit. However, there has been a problem that it is not possible to detect which of the transmission lines has caused the failure.

Although, in a device such as the FPGA, the LSI, or the memory, for example, a failure that a program logic of an internal processor is rewritten due to neutrons or the like in the atmosphere, or a failure that the internal processor malfunctions due to a bit garble by noise or the like may occur, the above-mentioned patent document 1 can not detect such a failure point in the processor within the device.

### SUMMARY OF THE INVENTION

It is accordingly an object of the present invention to provide a monitoring device (or method) and system which can detect a failure point of a processor within a device such as a FPGA, a LSI, or a memory and a failure point of a transmission line connected to the processor.

[1] In order to achieve the above-mentioned object, a monitoring device (or method) according to one aspect of the present invention comprises: a first means (or step of) inserting monitoring data of a predetermined pattern into an idle period of input data to be transmitted to a transmission line; a second means (or step of) selecting one or more processors arranged in the transmission line to make the selected processors process the monitoring data from the transmission line or diverting the monitoring data from all processors arranged in the transmission line; and a third means (or step of) determining whether or not the monitoring data outputted from the selected processors through the transmission line maintains the predetermined pattern by comparing the monitoring data with the predetermined pattern prestored, and detecting a failure point in the processors by controlling the second means (or step) to sequentially perform a selective switchover to the processors when determining that the predetermined pattern is not maintained.

The monitoring device (or method) according to the above-mentioned aspect of the present invention will now be described referring to the principle shown in FIG. 1, to which the present invention is not limited.

A monitoring device 10 shown in FIG. 1, in the same way as the prior art example shown in FIG. 19, includes the FPGA 100, the FPGA 200 provided with processors 210 and 220, the FPGA 300, and the memory MEM. Also, the FPGA 100 and the FPGA 200, as well as the FPGA 200 and FPGA 300 are respectively connected with the transmission lines L1 and L2 which are respectively composed of e.g. 32 channels. It is to be noted that a processor 110 within the FPGA 100 and a processor 310 within the FPGA 300 are not shown.

A monitoring data inserter 500 (corresponding to the above-mentioned first means) inserts monitoring data DT_MNT of a predetermined pattern shown in a portion (2) of FIG. 1 into an idle period T_IDLE between input data D1 and D2 shown in a portion (1) of FIG. 1 to be transmitted to the transmission line L1. A portion (3) of FIG. 1 shows this monitoring data DT_MNT[0]-DT_MNT[31] by channels CH0-CH31 (hereinafter, occasionally represented by a reference character CH) composing the transmission line L1.

Also, a selector 700_2 (corresponding to the above-mentioned second means) (hereinafter, occasionally represented by a reference numeral 700) is provided with switching points P3-P6 enabling selections of the following processing routes (a)-(d):

(a) a normal processing route of the FPGA 200 (a processing route (corresponding to the switching point P3) going through the processor 210→the memory MEM→the processor 220);

(b) a processing route (corresponding to the switching point P4) diverting from the rearmost processor 220;

(c) a processing route (corresponding to the switching point P5) diverting from the processor 220 and the memory MEM; and

(d) a processing route (corresponding to the switching point P6) diverting from all of the processors 210, 220, and the memory MEM.

In the normal state, i.e. when the switching point P3 is selected by the selector 700_2, the monitoring data DT_MNT is provided to all of the processor 210, the memory MEM, and processor 220 arranged in the transmission lines L1 and L2.

A monitoring data checker 600 (corresponding to the above-mentioned third means) having received the monitoring data DT_MNT through the transmission line L2 compares the pattern of the monitoring data DT_MNT with a predetermined pattern prestored. As a result, when determining that the predetermined pattern is maintained, the monitoring data checker 600 recognizes that a failure has not occurred in any of the processor 210, the memory MEM, and the processor 220, and deletes the monitoring data DT_MNT to transmit the data D1 and D2 as shown in a portion (4) of FIG. 1 to the subsequent stages.

On the other hand, when determining that the monitoring data DT_MNT does not maintain the predetermined pattern, the monitoring data checker 600 recognizes that a failure has occurred in any of the processor 210, the memory MEM, and the processor 220, and provides selective switchover instructions IND_S to the selector 700_2 for control thereof, thereby sequentially performing selective switchovers to the processor 210, the memory MEM, and the processor 220, namely selections of switching point P4→P5→P6 (the above-mentioned processing route (b)→(c)→(d)).

For example, when finding that the monitoring data DT_MNT has returned to normal after the switchover from the switching point P5 to the switching point P6, the monitoring data checker 600 detects the processor 210 as a failure point.

Thus, by the monitoring device (or method) in the aspect of the present invention, it is made possible to detect a failure point in a processor within a device such as the FPGA, the LSI, or the memory. Also, since a pair of the monitoring data inserter and the monitoring data checker has only to be provided to one monitoring device respectively at the head and end thereof, the parity bit generator and the parity bit checker per transmission line between the FPGAs as the prior art example shown in FIG. 19 become unnecessary, so that it is made possible to simplify a circuit within the device.

[2] Also, in the above-mentioned [1], the monitoring device may further comprise a fourth means switching over channels composing the transmission line at an output side of the processors, and the third means may include a means controlling the fourth means to detect which channel of an input side transmission line or output side transmission line of the processors has caused a failure when the failure point in the processors can not be detected.

Namely, when failing to detect any of the failure points in the processor 210, the memory MEM, and the processor 220 by the control to the selector 700_2 described in the above-mentioned [1], the monitoring data checker 600 provides channel switchover instructions IND_C to a switching portion 710 (corresponding to the above-mentioned fourth means) shown in FIG. 1 for the control thereof, thereby performing channel switchover of the transmission line L2.

For example, when determining that the monitoring data DT_MNT[31] corresponding to the channel CH31 shown in the portion (3) of FIG. 1 does not maintain the predetermined pattern, the monitoring data checker 600 recognizes that a failure has occurred at the channel CH31 of either of the transmission lines L1 and L2. However, it is uncertain which of the transmission lines L1 and L2 has caused the failure, so that the monitoring data checker 600 controls the switching portion 710 to switch over the channel CH31 of the transmission line L2 on the output side thereof to e.g. the channel CH30 of the transmission line L1 on the input side of the switching portion 710.

When finding that a pattern of the monitoring data DT_MNT[31] has returned to normal by this channel switchover, the monitoring data checker 600 regards or detects the channel CH31 of the transmission line L1 as the failure point. On the other hand, when the pattern of the monitoring data DT_MNT[31] has not returned to normal, the monitoring data checker 600 regards or detects the channel CH31 of the transmission line L2 as the failure point.

Thus, it is possible to detect the failure point in the channel of the transmission line between devices such as the FPGA, the LSI, and the memory.

[3] Also, in the above-mentioned [1], the monitoring device may further comprise a fourth means selectively providing the monitoring data to one or more second or third processors respectively arranged in an input side transmission line or output side transmission line of the processors to be processed, and the third means may detect a failure point in the second or third processors by controlling the fourth means to sequentially perform the selective switchover to the second or third processors.

Namely, even if the processor 110 within the FPGA 100 or the processor 310 within the FPGA 300 as shown in FIG. 19 is provided in the transmission line L1 as the input side transmission line or the transmission line L2 as the output side transmission line, in the same way as the selector 700_2 shown in FIG. 1, by making the monitoring device 10 further comprise a selector (corresponding to the above-mentioned fourth means) for selectively providing the monitoring data DT_MNT to the processor 110 or the processor 310 to be processed, and by providing selective switchover instructions IND_S to the selector for the control thereof to sequentially perform the selective switchover to the processor 110 or the processor 310 in the same way as the above-mentioned [1], it is possible for the monitoring data checker 600 to detect the processor 110 or the processor 310 as the failure point.

[4] Also, in the above-mentioned [1], the third means may include a means providing pattern switchover instructions of the monitoring data to the first means in order for the processors not to treat the monitoring data as invalid data.

Namely, in such a case that the processor 210 shown in FIG. 1 treats data other than a format that meets the standard of the Ethernet frame as invalid data to be discarded, such data should not be provided to the processor 210. Accordingly, it is possible for the monitoring data checker 600, as shown by dotted lines in FIG. 1, to provide monitoring data pattern switchover instructions IND_D for switching over the pattern of monitoring data DT_MNT to a pattern which is not treated as invalid data to the monitoring data inserter 500 only when providing the monitoring data DT_MNT to the processor 210.

Thus, without depending on the operation of a processor within a device such as the FPGA, the LSI, or the memory, it is possible to detect the failure point in the processor.

[5] Also, in the above-mentioned [1], the third means may control the second means only when determining equal to or more than a predetermined number of times that the monitoring data does not maintain the predetermined pattern.

Namely, in such a case that the failure in the processor within the FPGA has occurred by noise or the like only in that instant, there is a possibility that the failure is restored without having the recovery operation performed by the maintenance person.

In this case, it is possible for the monitoring data checker 600 to more accurately detect the failure point by controlling to the selector 700_2 as described in the above-mentioned [1] only when determining equal to or more than the predetermined number of times that the monitoring data DT_MNT does not maintain the predetermined pattern, namely, when determining that the failure has constantly occurred.

Thus, it becomes possible to continue the operations when the instantaneous failure has occurred, thereby preventing an unnecessary deterioration of the monitoring device availability.

[6] Also, in the above-mentioned [1], the third means may include a means controlling the second means to detect the failure point in the processors and to reconfigure the processors in which the failure point has been detected only when determining equal to or more than a predetermined number of times that the monitoring data does not maintain the predetermined pattern.

Namely, in the same way as the above-mentioned [5], it is possible for the monitoring data checker 600 to detect the failure point by controlling the selector 700_2 as described in the above-mentioned [1] only when determining that the failure has constantly occurred and reconfigure the processors in which the failure point has been detected.

Thus, the monitoring device can autonomously restore the failure and continue the operations.

[7] Also, in the above-mentioned [1], the input data may comprise an Ethernet frame, and the monitoring device may further comprise a fourth means storing the Ethernet frame in a buffer, and a fifth means reading equal to or more than a predetermined number of Ethernet frames all at one time out of the buffer and generating the idle period by a summation of inter-frame gaps between the Ethernet frames read.

Namely, if the input data DT comprises an Ethernet frame, a fourth means stores the Ethernet frame in a buffer.

Since IFGs (Inter Frame Gaps) respectively exist between Ethernet frames, even in such a case that the Ethernet frames are inputted to the monitoring device 10 at e.g. a maximum transmission rate so that there is no idle period T_IDLE for inserting the monitoring data DT_MNT thereinto, it is possible for a fifth means to read equal to or more than a predetermined number of the Ethernet frames all at one time out of the buffer, thereby generating the idle period T_IDLE by a summation of the IFGs between the Ethernet frames read.

[8] Also, in the above-mentioned [1], the monitoring device may further comprise a fourth means storing the input data in a buffer, and a fifth means providing a clock rate higher than that of the input data to the buffer, reading the input data out of the buffer, and generating the idle period by a difference between both clock rates.

Namely, in the same way as the above-mentioned [7], even in such a case that the data DT are inputted to the monitoring device 10 at e.g. a maximum transmission rate and there is no idle period T_IDLE for inserting the monitoring data DT_MNT thereinto, a fourth means stores the data DT in a buffer and a fifth means reads equal to or more than a predetermined number of the data DT all at one time out of the buffer by providing a clock rate higher than that of the data DT to the buffer, whereby a difference between both clock rates can be made the idle period T_IDLE.

[9] Also, a monitoring system according to one aspect of the present invention in order to achieve the above-mentioned object comprises a plurality of the monitoring devices 10 described in any one of the above-mentioned [1]-[8] as a working system and a protection system respectively, in which each of the monitoring data checkers 600 of the monitoring devices is provided with a means notifying an error outward when determining that the monitoring data DT_MNT does not maintain the predetermined pattern.

Namely, when a monitoring data checker 600 of one monitoring device as a working system detects the failure point in the channel of the transmission line between devices such as the FPGA, the LSI, and the memory or the failure point in the processor within the device, an error is further notified outward, e.g. to the switching equipment 3 shown in FIG. 18.

In this case, the switching equipment 3 to which the error has been notified switches over the monitoring device having caused the failure to another monitoring device as a protection system, thereby enabling the operations to be continued without deteriorating the availability of the entire monitoring system.

According to the present invention, the failure point in the channel of the transmission line between devices such as the FPGA, the LSI, and the memory and the failure point in the processor within the device can be concurrently detected, so that a speedy and effective performance of the recovery operation for the failure is enabled.

Furthermore, it is made possible to perform the pattern switchover of the monitoring data used for detecting the failure point. Therefore, the failure point can be detected without depending on the operation of the processor within the device.

Also, even in such a case that the data are inputted to the monitoring device or the monitoring system at the maximum transmission rate, it is made possible to generate the idle period for inserting the monitoring data thereinto. Therefore, the failure point can be detected without depending on a transmission rate of environment where the monitoring device or monitoring system is operated.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing the principle of a monitoring device according to the present invention;

FIG. 2 is a block diagram showing an embodiment [1] of a monitoring device according to the present invention;

FIG. 3 is a flowchart showing an overall operation of a monitoring device according to the present invention;

FIGS. 4A-4C are diagrams showing embodiments of data and monitoring data used for a monitoring device according to the present invention;

FIGS. 5A and 5B are block diagrams showing pattern examples of monitoring data used for a monitoring device according to the present invention;

FIG. 6 is a block diagram showing a monitoring example (1) of an embodiment [1] of a monitoring device according to the present invention;

FIG. 7 is a block diagram showing a monitoring example (2) of an embodiment [1] of a monitoring device according to the present invention;

FIG. 8 is a block diagram showing a monitoring example (3) of an embodiment [1] of a monitoring device according to the present invention;

FIG. 9 is a block diagram showing a monitoring example (4) of an embodiment [1] of a monitoring device according to the present invention;

FIG. 10 is a block diagram showing a monitoring example (5) of an embodiment [1] of a monitoring device according to the present invention;

FIG. 11 is a block diagram showing a monitoring example (6) of an embodiment [1] of a monitoring device according to the present invention;

FIGS. 12A and 12B are block diagrams showing channel switchover examples of a monitoring device according to the present invention;

FIG. 13 is a flowchart showing a monitoring data checking example (1) of a monitoring device according to the present invention;

FIG. 14 is a flowchart showing a monitoring data checking example (2) of a monitoring device according to the present invention;

FIG. 15 is a block diagram showing an embodiment [2] of a monitoring device according to the present invention;

FIG. 16 is a block diagram showing an embodiment [3] of a monitoring device according to the present invention;

FIG. 17 is a block diagram showing an embodiment [4] of a monitoring system according to the present invention;

FIG. 18 is a block diagram showing an arrangement of a frame switching system to which the present invention and the prior art example are applied; and

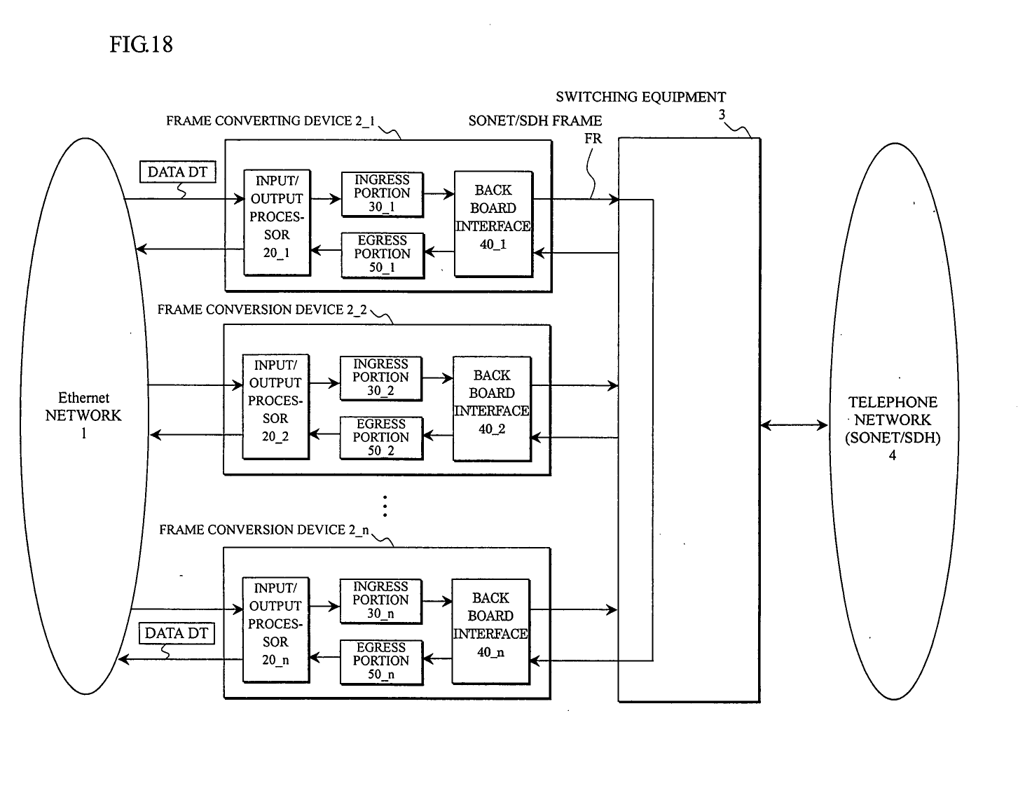

FIG. 19 is a block diagram showing a prior art example of a monitoring device.

### DESCRIPTION OF THE EMBODIMENTS

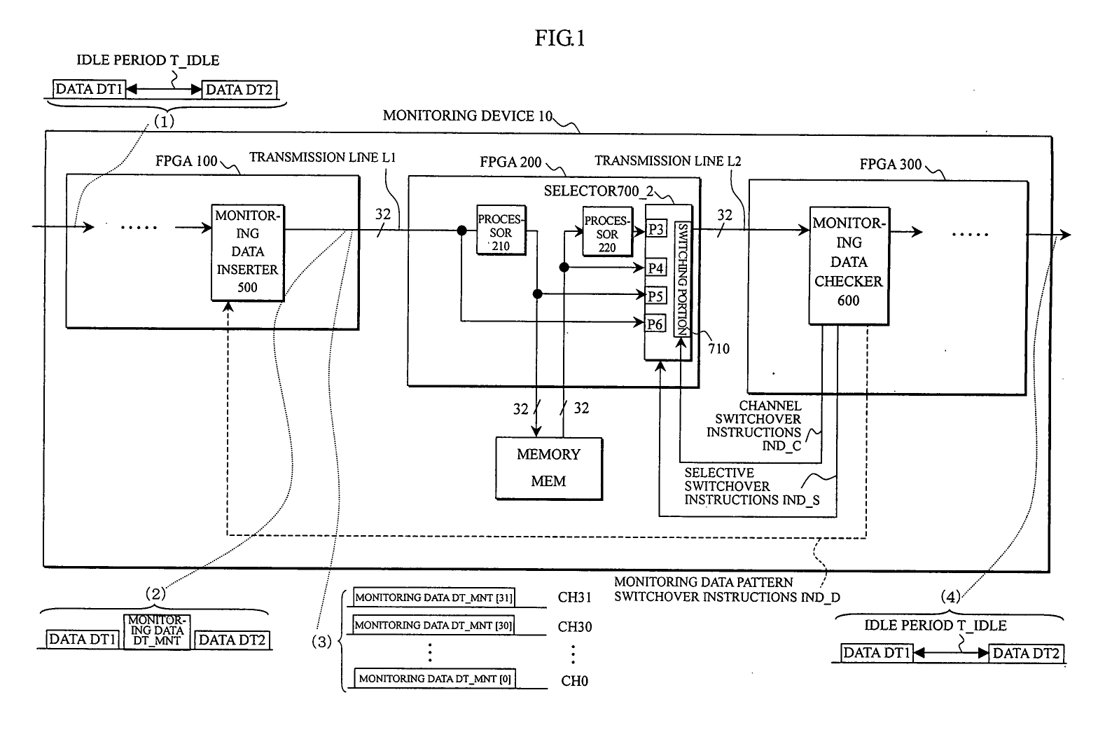

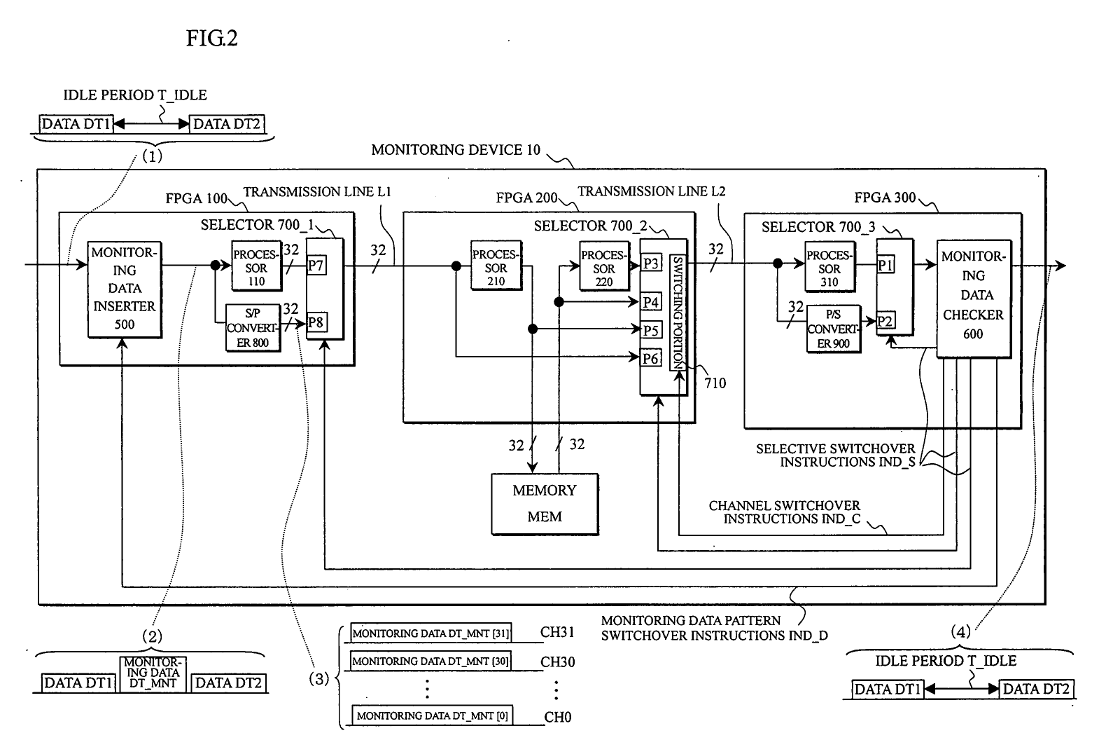

Embodiments [1]-[3] of the monitoring device and an Embodiment [4] of the monitoring system according to the present invention is shown in principle in FIG. 1 will now be described referring to FIGS. 2, 3, 4A, 4B, 4C, 5A, 5B, 6-11, 12A, 12B, and 13-17.

### ⊚Embodiment [1]: FIGS. 2, 3, 4A-4C, 5A, 5B, 6-11, 12A, 12B, 13, and 14

### [1]-1 Arrangement: FIG. 2

The monitoring device 10 shown in FIG. 2 includes, in the same way as FIG. 1, the FPGA 100 provided with the monitoring data inserter 500, the FPGA 200 provided with the processors 210 and 220, the selector 700_2, and the switching portion 710, the FPGA 300 provided with the monitoring data checker 600, and the memory MEM. Also, the FPGA 100 and the FPGA 200, as well as the FPGA 200 and FPGA 300 are respectively connected with the transmission lines L1 and L2 which are respectively composed of e.g. 32 channels.

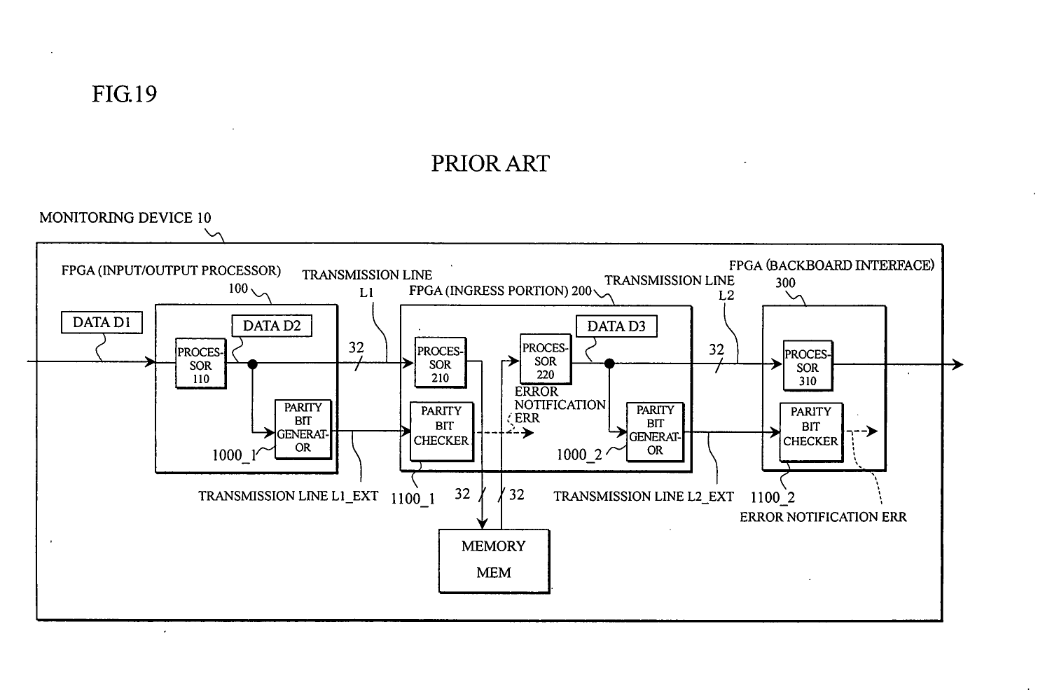

Furthermore, the FPGA 100 and the FPGA 300 are respectively provided with, in addition to the arrangement shown in FIG. 1, the processor 110 and the processor 310 as shown in FIG. 19, and selectors 700_1 and 700_3 respectively and selectively providing the monitoring data DT_MNT to these processors 110 and 310. Also, to a switching point P8 of the selector 700_1, as shown in a portion (3) of FIG. 2, an S/P converter 800 for converting in parallel the monitoring data DT_MNT into the monitoring data DT_MNT[0]-DT_MNT[31] corresponding to the channels CH0-CH31 of the transmission line L1 is connected; and, to a switching point P2 of the selector 700_3, a P/S converter 900 for converting in series the monitoring data DT_MNT[0]-DT_MNT[31] received through the transmission line L2 into the monitoring data DT_MNT is connected.

It is to be noted that, in this embodiment, while the FPGA 400 corresponding to the egress portion 50 is omitted or not shown for the sake of simplification of figures, the following description is similarly applied only with the signal flow being reversed. The same applies to the embodiments [2]-[4], which will be described later.

### [1]-2 Operation: FIGS. 2, 3, 4A-4C, 5A. 5B, 6-11, 12A, 12B, 13, and 14

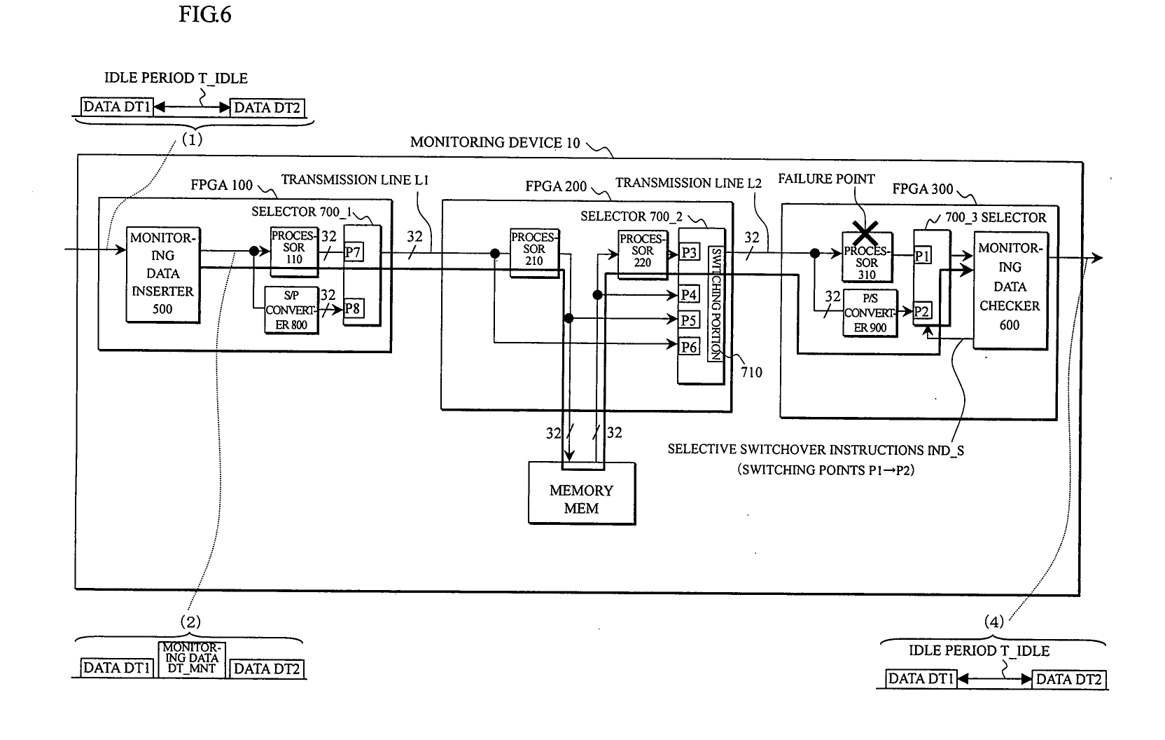

The operation of this embodiment will now be described. Firstly, the overall operation will be described referring to FIGS. 2, 3, 4A-4C, 5A, and 5B. Then, monitoring examples (1)-(6) respectively corresponding to a total of five ways of the selective switchovers to the switching points P1-P8 of the selectors 700_1-700_3 (i.e. (1): the switching point P1→P2, (2): P3→P4, (3): P4→P5, (4): P5→P6, (5): P7→P8) and the channel switchover (6) of the transmission line L2 by the switching portion 710 will be described respectively referring to FIGS. 6-11, 12A, and 12B.

### Overall Operation: FIGS. 2, 3, 4A-4C, 5A, and 5B

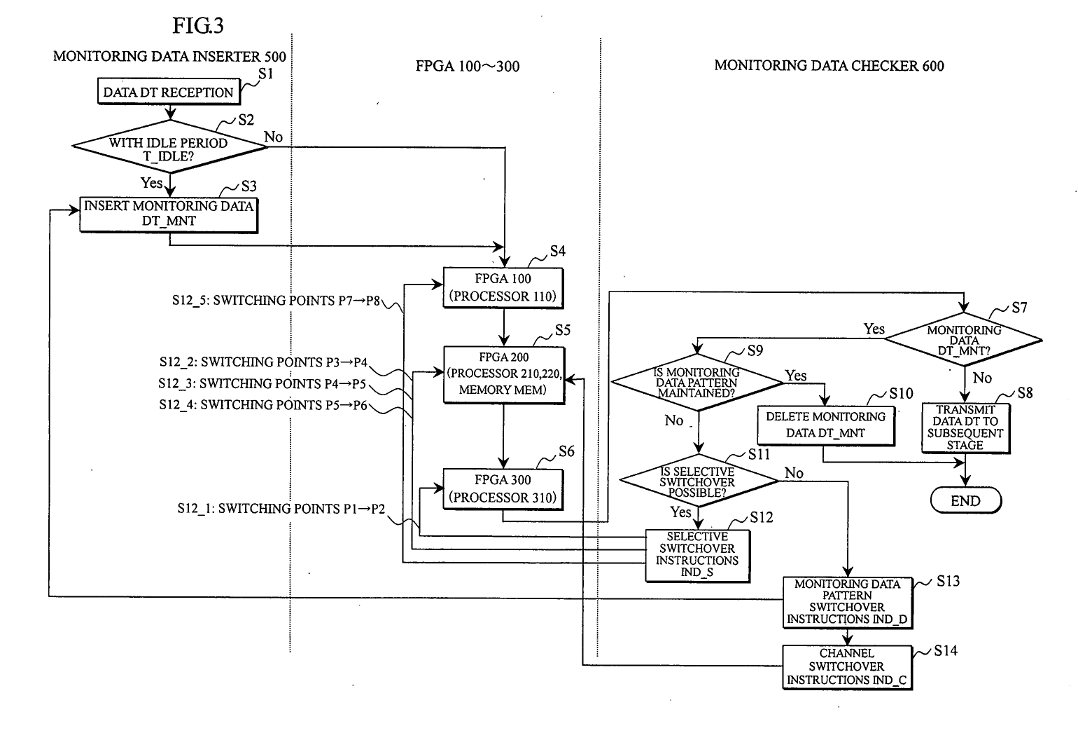

FIG. 3 is a flowchart showing an overall operation of the monitoring device 10 shown in FIG. 2.

It is now supposed that in the selectors 700_1-700_3 of this monitoring device 10, the switching points P7, P3, and P1 have been respectively selected so as to provide the monitoring data DT_MNT to all of the processors (the processor 110, the processors 210 and 220, the memory MEM, and the processor 310).

In this state, when the data DT1 and DT2 are inputted to the monitoring device 10 as shown in a portion (1) of FIG. 2 (at step S1), the monitoring data inserter 500 determines whether or not there is the idle period T_IDLE for inserting the monitoring data DT_MNT thereinto (at step S2). When determining that there is the idle period T_IDLE, the monitoring data inserter 500, as shown in a portion (2) of FIG. 2, inserts the monitoring data DT_MNT of the predetermined pattern into the idle period T_IDLE and provides the monitoring data DT_MNT to the processor 110 within the FPGA 100 (at step S3).

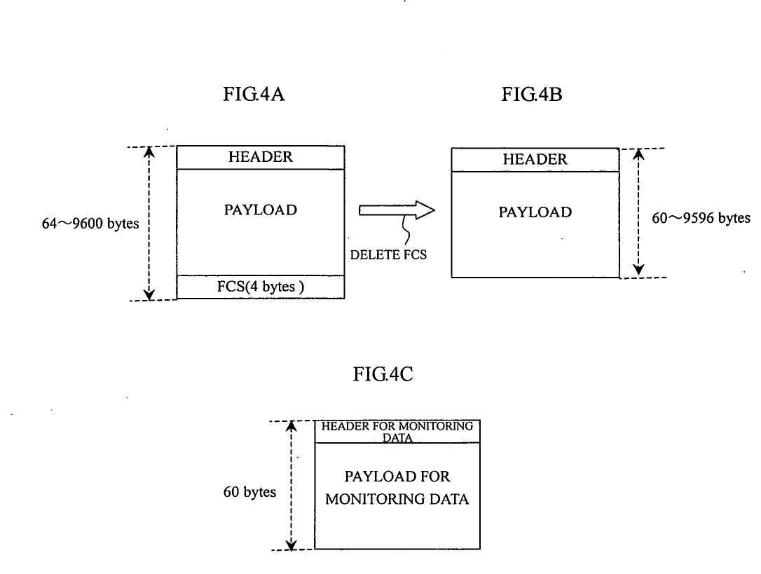

If the input data DT is the Ethernet frame (64 bytes-9600 bytes) composed of a header, a payload, and 4 bytes of FCS (Frame Check Sequence) as shown in FIG. 4A for example, the data DT with the FCS deleted is transferred through the monitoring device 10 as shown in FIG. 4B.

Therefore, as shown in FIG. 4C for example, the monitoring data DT_MNT is composed of a total of 60 bytes of a header for the monitoring data (e.g. 4 bytes) and a payload for the monitoring data (e.g. 56 bytes) so as to correspond to the format of the data DT and be identified as the monitoring data DT_MNT by the monitoring data checker 600 which will be described later.

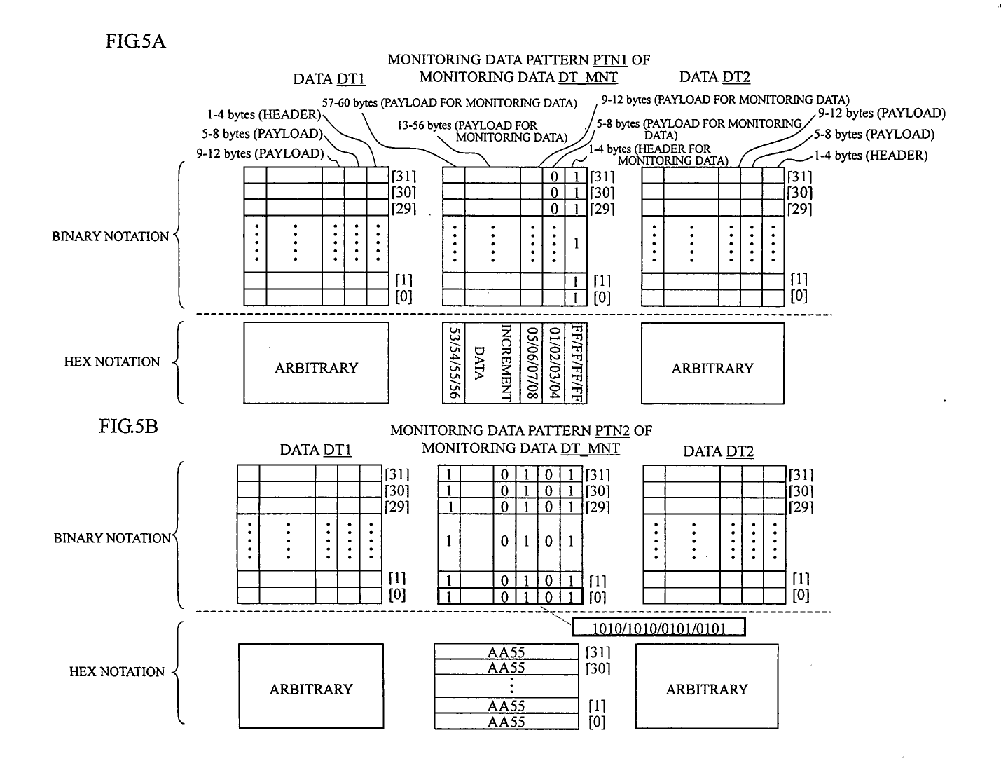

For example, a pattern of the monitoring data DT_MNT as mentioned above is a monitoring data pattern PTN1 (hereinafter, occasionally represented by a reference character PTN) as shown in FIG. 5A. In this monitoring data pattern PTN1, all of 4 bytes of the header for the monitoring data are set with “1” (“FF/FF/FF/FF” in the HEX notation) and a total of 56 bytes of the payload for the monitoring data are set with data incremented by “1” per 1 byte (“01/02/03/ . . . /53/54/55/56” in the HEX notation). Hereinafter, until a pattern switchover of the monitoring data, which will be described later, is performed by the monitoring data checker 600, the monitoring data DT_MNT assumes this monitoring data pattern PTN1. A monitoring data pattern PTN2 will be described later.

It is to be noted that the monitoring data checker 600 need not necessarily perform the monitoring data pattern switchover, and that only when there is a processor processing the monitoring data DT_MNT as the invalid data, the monitoring data checker 600 has only to switch over the monitoring data pattern PTN so as not to be treated as the invalid data.

The processor 110 having received the monitoring data DT_MNT transmits this monitoring data DT_MNT to the transmission line L1 through the switching point P7 of the selector 700_1 (at step S4) after having performed e.g. the same processing as that of the processor 110 shown in FIG. 19.

The processor 210 within the FPGA 200 having received the monitoring data DT_MNT through the transmission line L1 writes this monitoring data DT_MNT in the memory MEM after having performed e.g. the same processing as that of the processor 210 shown in FIG. 19. The processor 220 reads the monitoring data DT_MNT out of the memory MEM to be transmitted to the transmission line L2 through the switching point P3 of the selector 700_3 (at step S5).

The processor 310 within the FPGA 300 having received the monitoring data DT_MNT through the transmission line L2 provides this monitoring data DT_MNT to the monitoring data checker 600 through the switching point P1 of the selector 700_3 (at step S6) after having performed e.g. the same processing as that of the processor 310 shown in FIG. 19.

The monitoring data checker 600 having received the monitoring data DT_MNT determines whether or not it is the monitoring data DT_MNT, namely, whether or not the monitoring data DT_MNT is composed of the format as shown in FIG. 4B (at step S7). When determining that it is not the monitoring data DT_MNT, the monitoring data checker 600 regards it as the normal data DT to be transmitted to the subsequent stages (at step S8).

Also, at the above-mentioned step S7, when determining that it is the monitoring data DT_MNT, the monitoring data checker 600 further compare the monitoring data pattern PTN1 of this monitoring data DT_MNT with the monitoring data pattern PTN1 internally prestored (at step S9). As a result, when determining that the monitoring data DT_MNT maintains the monitoring data pattern PTN1, the monitoring data checker 600 deletes the monitoring data DT_MNT (at step S10). This is because the monitoring data DT_MNT should not be transmitted to the subsequent stages.

On the other hand, at the above-mentioned step S9, when determining that the monitoring data DT_MNT does not maintain the monitoring data pattern PTN1, the monitoring data checker 600 further determines whether or not the selective switchovers to the processors can be still performed, namely, whether or not the selective switchovers to all of the processors have been finished (at step S11). When determining that the selective switchover can be still performed, the monitoring data checker 600 provides the selective switchover instructions IND_S to the selectors 700_1-700_3 and sequentially performs the selective switchovers to the switching points P1-P8 (at step S12).

In this example, until detecting the processor which have caused the failure (until determining that the monitoring data DT_MNT is normal), the monitoring data checker 600 continues to execute switchovers in the order of the following steps S12_1-S12_5 (in the order from the switching point close to the monitoring data checker 600 itself). It is to be noted that the channel switchover of the selector 710 is performed when the failure point can not be detected even if these switchovers are executed.

Step S12_1: a switchover of the switching points P1→P2 in the selector 700_3.

Step S12_2: a switchover of the switching points P3→P4 in the selector 700_2.

Step S12_3: a switchover of the switching points P4→P5 in the selector 700_2.

Step S12_4: a switchover of the switching points P5→P6 in the selector 700_2.

Step S12_5: a switchover of the switching points P7→P8 in the selector 700_1.

At the above-mentioned step S11, when determining that the selective switchovers to the processors can not be performed, the monitoring data checker 600 provides the monitoring data pattern switchover instructions IND_D to switch over the monitoring data DT_MNT to the monitoring data pattern PTN2 as shown in FIG. 5B to the monitoring data inserter 500 (at step S13). The monitoring data inserter 500 having received the monitoring data pattern instructions IND_D switches over the pattern of the monitoring data DT_MNT to be inserted to the monitoring data pattern PTN2.

The monitoring data pattern PTN2 is different from the above-mentioned monitoring data pattern PTN1 in that the monitoring data DT_MNT[0]-DT_MNT[31] corresponding to the channels CH0-CH31 of the transmission lines L1 and L2 are respectively set with e.g. “1010/1010/0101/0101” (“AA55” in the HEX notation).

Then, the monitoring data checker 600 provides the channel switchover instructions IND_C to the switching portion 710 to perform the channel switchover of the transmission line L2 (at step S14).

The monitoring examples (1)-(6) when the switchovers in the switching points P1-P8 and the channel switchover of the transmission line L2 as mentioned above are performed will now be described.

### Monitoring Example (1) (Switching Points P1→P2): FIG. 6

FIG. 6 shows the monitoring device 10 shown in FIG. 2, emphasizing the monitoring example when the selector 700_3 is switched over from the switching point P1 to the switching point P2.

As having described referring to FIG. 3, the monitoring data checker 600 having received the monitoring data DT_MNT provides the selective switchover instructions IND_S to the selector 700_3 to perform the switchover from the switching point P1 to the switching point P2 so as not to provide the monitoring data DT_MNT to the processor 310 when determining that the monitoring data pattern PTN1 is not maintained.

If it is now supposed that a failure × has occurred in the processor 310, after the above-mentioned switchover, the monitoring data checker 600 recognizes that the monitoring data pattern PTN1 has returned to normal, and therefore detects the processor 310 as the failure point.

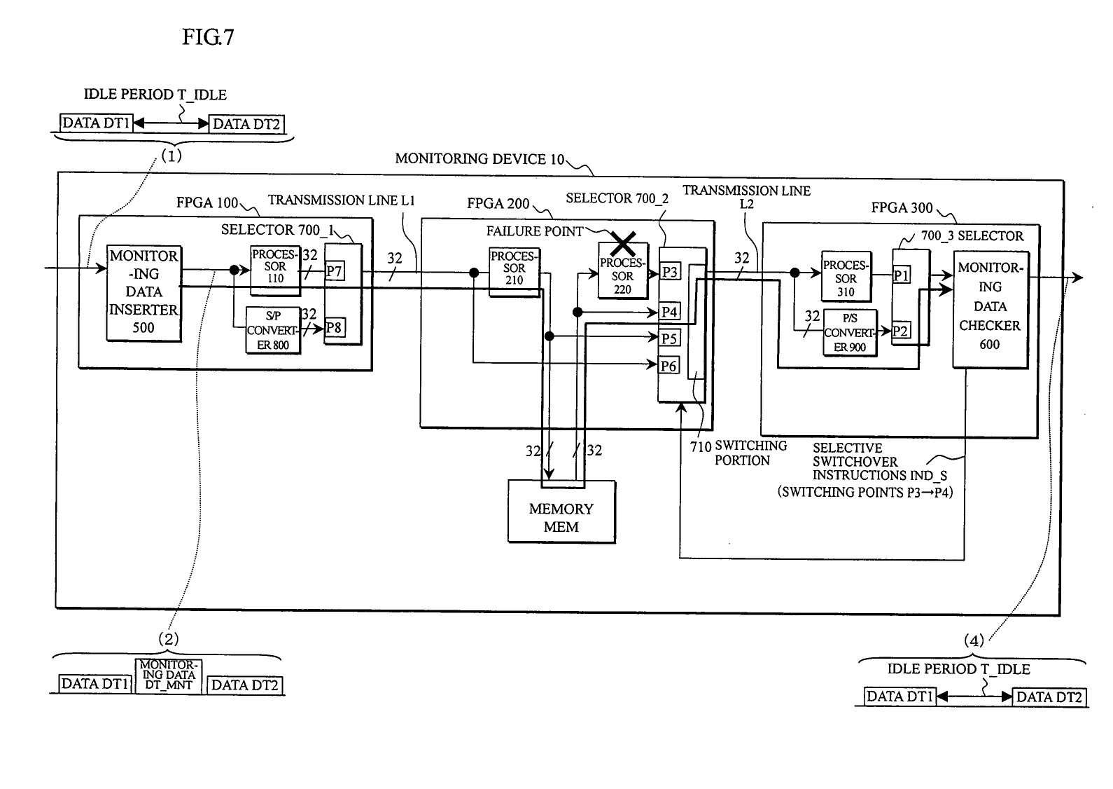

### Monitoring Example (2) (Switching Points P3→P4): FIG. 7

FIG. 7 shows the monitoring device 10 shown in FIG. 2, emphasizing the monitoring example when the selector 700_2 is switched over from the switching point P3 to the switching point P4.

When failing to detect the failure point in the above-mentioned monitoring example (1), the monitoring data checker 600 further provides the selective switchover instructions IND_S to the selector 700_2 to perform the switchover from the switching point P3 to the switching point P4 so as not to provide the monitoring data DT_MNT neither to the processor 220.

If it is now supposed that the failure × has occurred in the processor 220, after the above-mentioned switchover, the monitoring data checker 600 recognizes that the monitoring data pattern PTN1 has returned to normal, and therefore detects the processor 220 as the failure point.

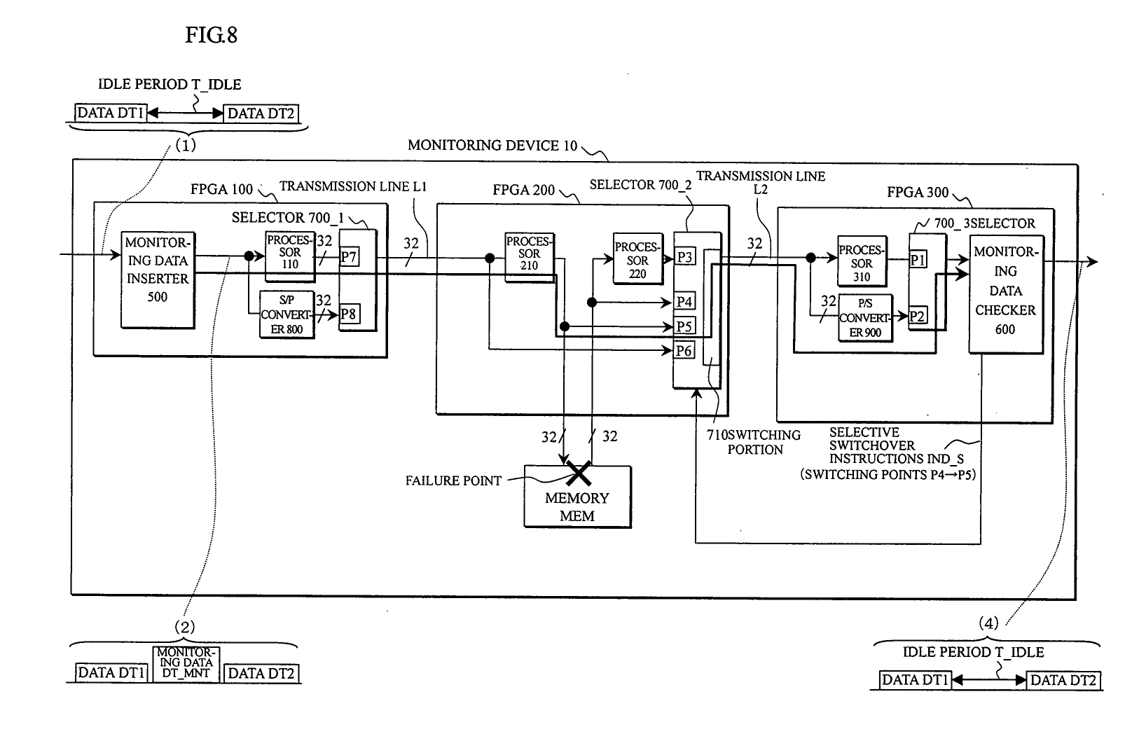

### Monitoring Example (3) (Switching Points P4→P5): FIG. 8

FIG. 8 shows the monitoring device 10 shown in FIG. 2, emphasizing the monitoring example when the selector 700_2 is switched over from the switching point P4 to the switching point P5.

When failing to detect the failure point in the above-mentioned monitoring examples (1) and (2), the monitoring data checker 600 further provides the selective switchover instructions IND_S to the selector 700_2 to perform the switchover from the switching point P4 to the switching point P5 so as not to provide the monitoring data DT_MNT neither to the memory MEM that is one of the processors.

If it is now supposed that the failure × has occurred in the memory MEM, after the above-mentioned switchover, the monitoring data checker 600 recognizes that the monitoring data pattern PTN1 has returned to normal, and therefore detects the memory MEM as the failure point.

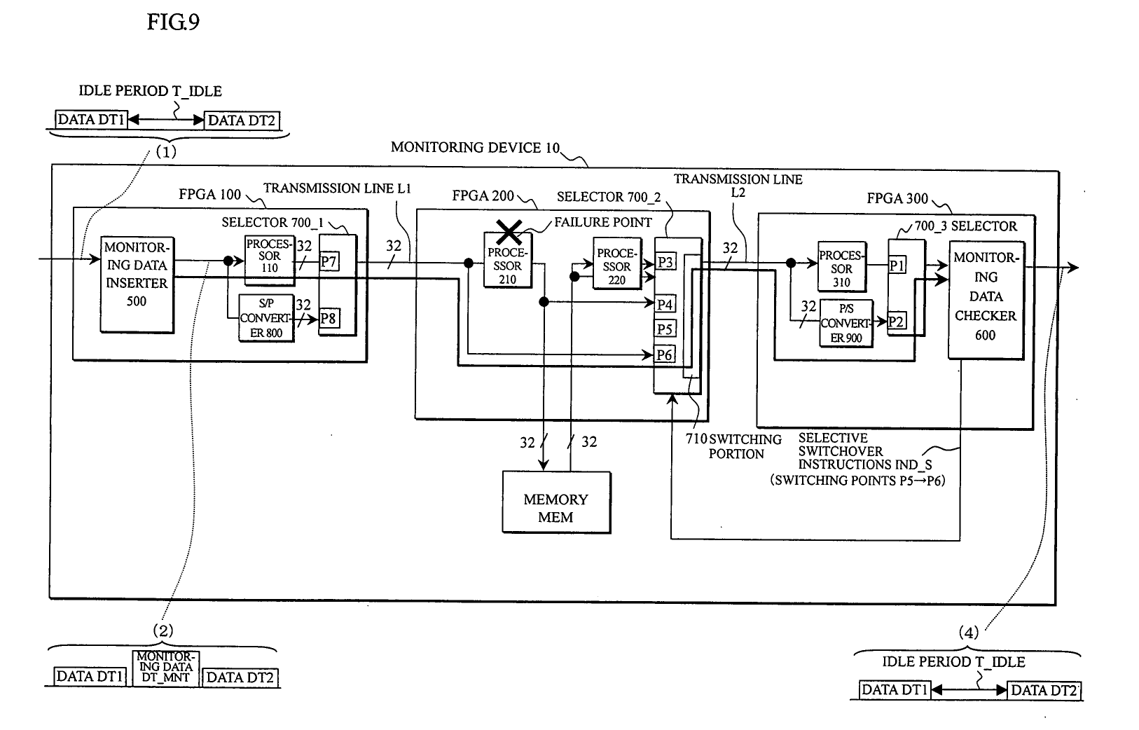

### Monitoring Example (4) (Switching Points P5→P6): FIG. 9

FIG. 9 shows the monitoring device 10 shown in FIG. 2, emphasizing the monitoring example when the selector 700_2 is switched over from the switching point P5 to the switching point P6.

When failing to detect the failure point in the above-mentioned monitoring examples (1)-(3), the monitoring data checker 600 further provides the selective switchover instructions IND_S to the selector 700_2 to perform the switchover from the switching point P5 to the switching point P6 so as not to provide the monitoring data DT_MNT neither to the processor 210.

If it is now supposed that the failure × has occurred in the processor 210, the monitoring data checker 600 recognizes after the above-mentioned switchover that the monitoring data pattern PTN1 has returned to normal, and therefore detects the processor 210 as the failure point.

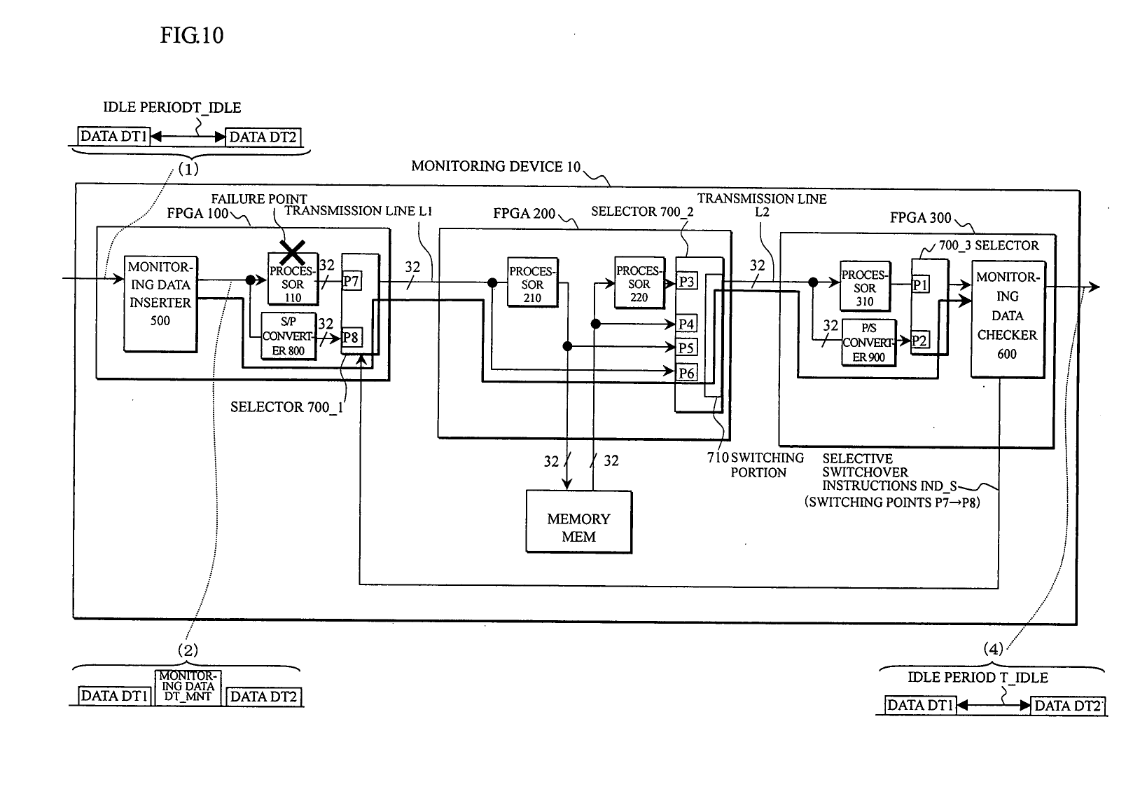

### Monitoring Example (5) (Switching Points P7→P8): FIG. 10

FIG. 10 shows the monitoring device 10 shown in FIG. 2, emphasizing the monitoring example when the selector 700_1 is switched over from the switching point P7 to the switching point P8.

When failing to detect the failure point in the above-mentioned monitoring examples (1)-(4), the monitoring data checker 600 further provides the selective switchover instructions IND_S to the selector 700_1 to perform the switchover from the switching point P7 to the switching point P8 so as not to provide the monitoring data DT_MNT neither to the processor 110.

If it is now supposed that the failure × has occurred in the processor 110, the monitoring data checker 600 recognizes after the above-mentioned switchover that the monitoring data pattern PTN1 has returned to normal, and therefore detects the processor 110 as the failure point.

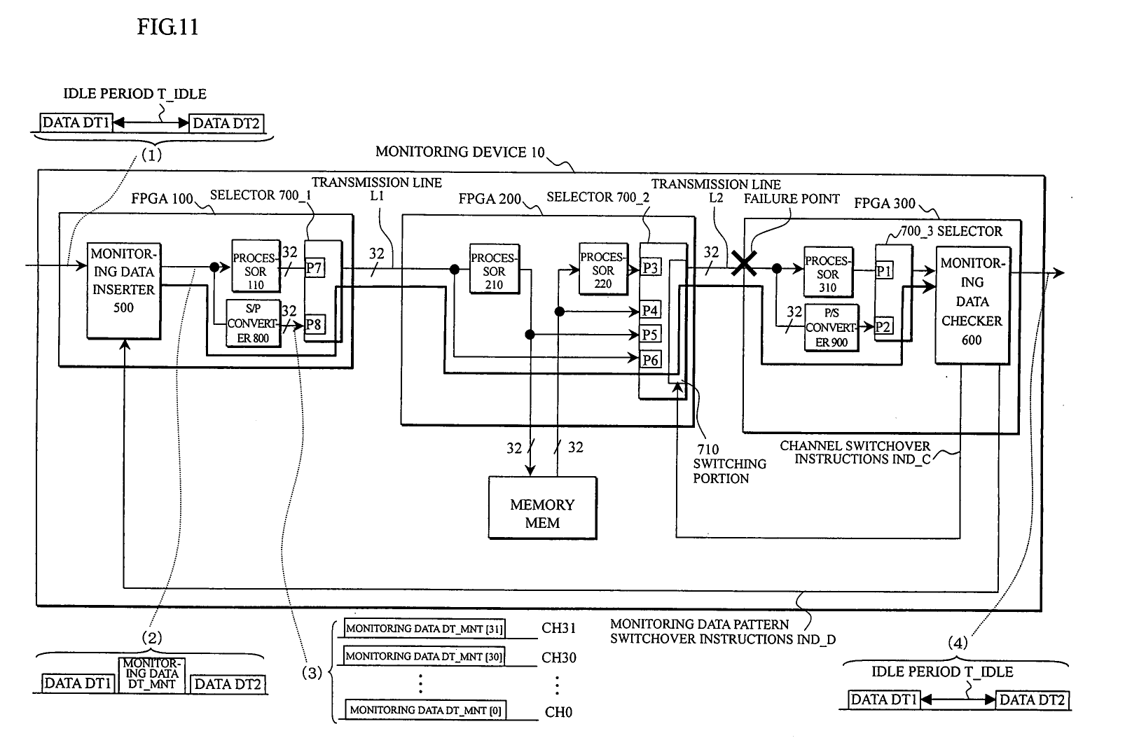

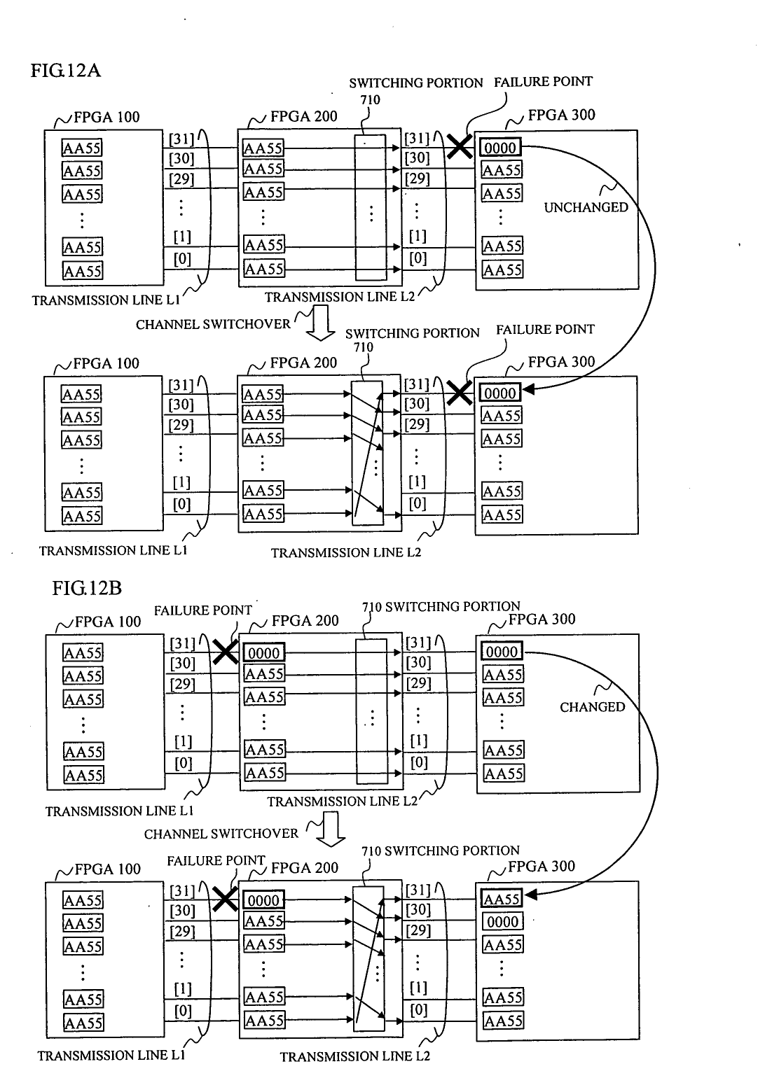

### Monitoring Example (6) (Channel Switchover): FIG. 11 and 12

FIG. 11 shows the monitoring device 10 shown in FIG. 2, emphasizing the monitoring example when the channel switchover of the transmission line L2 is performed by the switching portion 710.

When failing to detect the failure point in the above-mentioned monitoring examples (1)-(5), the monitoring data checker 600 recognizes that the failure has occurred not in the FPGAs 100-300 but in either of the transmission line L1 and L2. The monitoring data checker 600 provides the monitoring data pattern switchover instructions IND_D to the monitoring data inserter 500 so as to switch over the monitoring data DT_MNT to the monitoring data pattern PTN2, and then provides the channel switchover instructions IND_C to the switching portion 710 to perform the channel switchover of the transmission line L2.

It is now supposed that the failure × has occurred at the channel CH31 of the transmission line L2 as shown in FIG. 12A. In this case, the monitoring data checker 600, as shown in FIG. 12A, recognizes that only the monitoring data DT_MNT[31] corresponding to the channel CH31 does not maintain the monitoring data pattern PTN2, namely the pattern of the monitoring data DT_MNT[31] is not “AA55” but e.g. “0000”.

In order to detect whether the channel CH31 of the transmission line L1 or the channel CH31 of the transmission line L2 has caused the failure, the monitoring data checker 600 switches over the channel CH31 of the transmission line L2 not to the channel CH31 of the transmission line L1 but to other channel (e.g. the channel CH0 as shown in FIG. 12A) by controlling the switching portion 710. In this example, the channels CH0-CH31 of the transmission line L2 are respectively connected to the channels CH0-CH31 of the transmission line L1 shifted by one channel as shown in FIG. 12A.

As a result, the monitoring data checker 600 recognizes even after the above-mentioned channel switchover that the pattern of the monitoring data DT_MNT[31] still remains as the pattern of “0000” unchanged, namely, a pattern abnormality of the monitoring data DT_MNT[31] has occurred at the channel CH31 of the transmission line L2, and therefore detects the channel CH31 of the transmission line L2 as the failure point.

Also, as shown in FIG. 12B, when the failure has occurred not in the transmission line L2 but at the channel CH31 of the transmission line L1, if it is supposed that the monitoring data checker 600 performs the channel switchover of the switching portion 710 in the same way as the example of FIG. 12A and that the pattern of the monitoring data DT_MNT[31] has changed to the pattern of “AA55” or returned to normal, the monitoring data checker 600 can recognize that the pattern abnormality of the monitoring data DT_MNT[31] has occurred at the channel CH31 of the transmission line L1, and therefore detects the channel CH31 of the transmission line L1 as the failure point.

While the monitoring data checker 600 is made to immediately control the selectors 700_1-700_3 and the switching portion 710 when determining even once that the monitoring data pattern PTN is not maintained at the step S9 shown in FIG. 3, the monitoring data checker 600 can perform controls like monitoring data checking examples (1) and (2) which will be described bellow. The same applies to the embodiments [2]-[4] which will be described later.

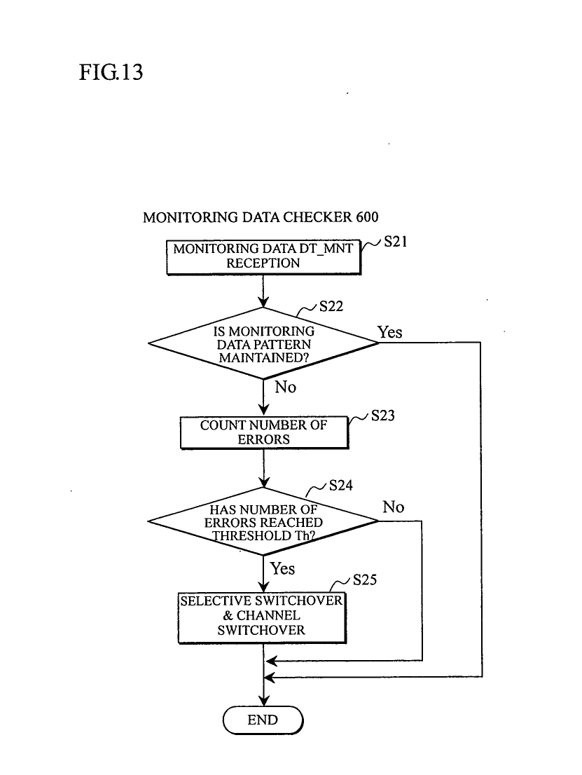

### Monitoring Data Checking Example (1): FIG. 13

As shown in FIG. 13, every time having received the monitoring data DT_MNT (at step S21), the monitoring data checker 600 compares the pattern PTN of this monitoring data DT_MNT with the monitoring data pattern PTN prestored (at step S22). As a result, when determining that the monitoring data pattern PTN is not maintained, the monitoring data checker 600 recognizes a possibility that the failure has occurred, namely, an occurrence of instantaneous failure or constant failure as mentioned above, and counts the number of errors (at step S23).

When the number of errors counted at the above-mentioned step S23 has reached a threshold Th (at step S24), the monitoring data checker 600 determines that the failure has constantly occurred and controls the selectors 700_1-700_3 and the switching portion 710 as mentioned above to perform the selective switchover and the channel switchover (at step S25).

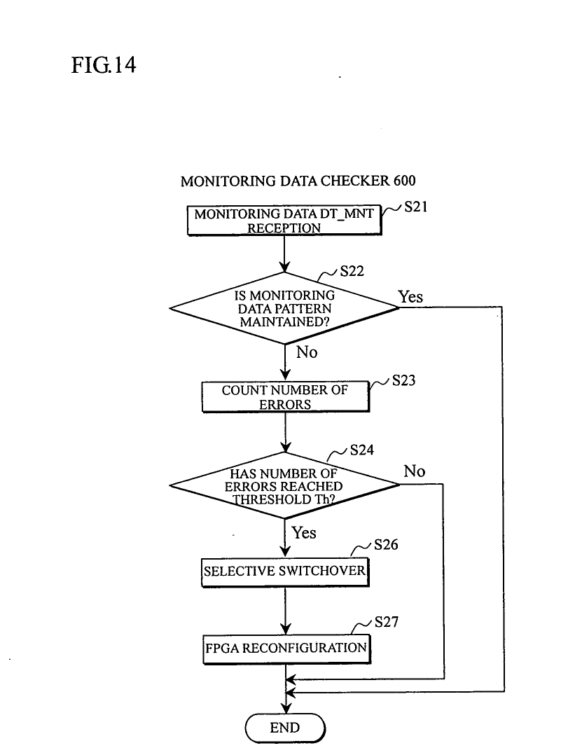

### Monitoring Data Checking Example (2): FIG. 14

At step S24 shown in FIG. 14, when determining that the failure has constantly occurred in the same way as the above-mentioned monitoring data checking example (1), the monitoring data checker 600 controls the selector 700_1-700_3 to perform the selective switchover, thereby detecting the processor which have caused the failure (at step S26), different from the above-mentioned monitoring data checking example (1).

The monitoring data checker 600 reconfigures the processor in which the failure point is detected at the above-mentioned step S26 (at step S27).

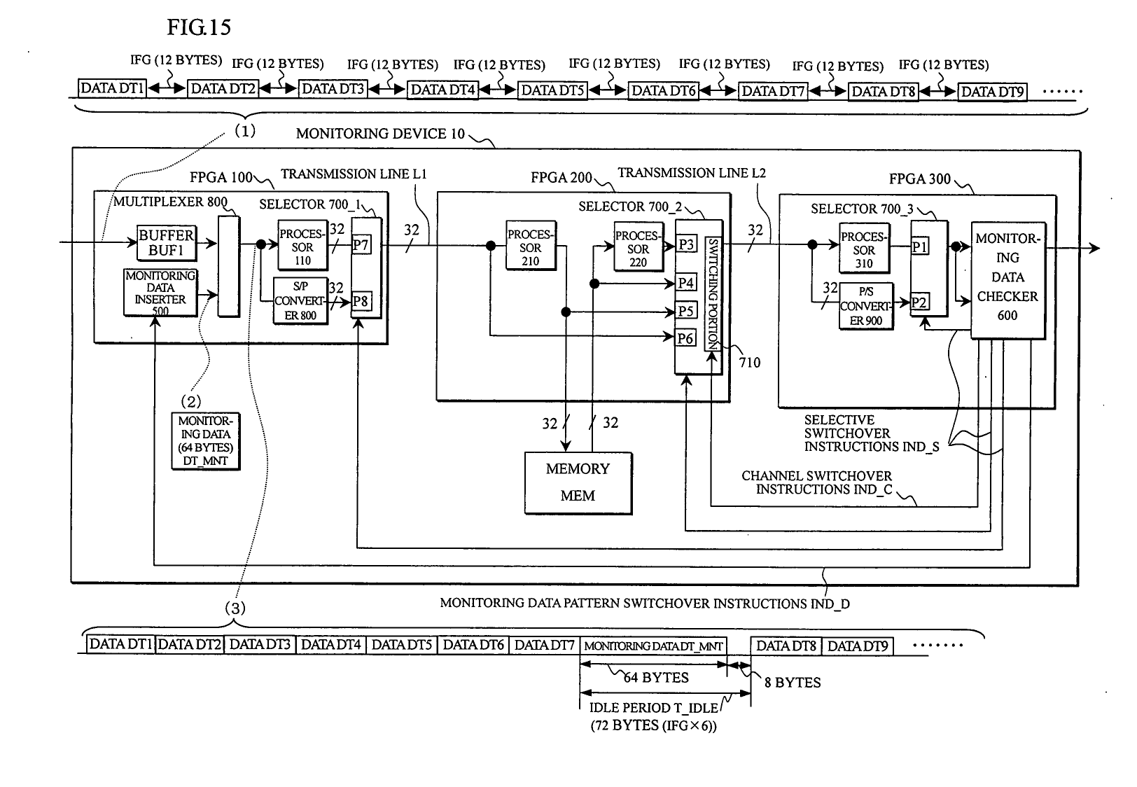

### ⊚Embodiment [2]: FIG. 15

The monitoring device 10 shown in FIG. 15 is provided with, in addition to the arrangement described in the above-mentioned embodiment [1], a buffer BUF1 for storing the data DT as the Ethernet frame in the FPGA 100, and a multiplexer 800 for reading equal to or more than a predetermined number of the data DT all at one time out of the buffer BUF1 and multiplexing the data DT read and the monitoring data DT_MNT provided from the monitoring data inserter 500.

As shown in a portion (1) of FIG. 15, when data DT1-DT9, which are the Ethernet frames and respectively have 12 bytes of IFG between the data, are inputted to the FPGA 100 at e.g. the maximum transmission rate, these data DT1-DT9 are stored in the buffer BUF1.

In order to enable the monitoring data DT_MNT of e.g. 64 bytes provided from the monitoring data inserter 500 as shown in a portion (2) of FIG. 15 to be transmitted to processors and transmission lines at the subsequent stages, the multiplexer 800, as shown in a portion (3) of FIG. 15, reads e.g. 7 data DT1-DT7 all at one time out of the buffer BUF1, generates a total of 72 bytes of the idle period T_IDLE by the summation of 6 IFGs between these data DT1-DT7, and inserts the monitoring data DT_MNT into this idle period T_IDLE to be multiplexed.

Thus, even if the Ethernet frames are inputted at the maximum transmission rate, since the monitoring data DT_MNT can be respectively provided to the processor 110 within the FPGA 100, the processors 210 and 220 within the FPGA 200, the processor 310 within the FPGA 300, the transmission line L1 between the FPGA 100 and the FPGA 200, and the transmission line L2 between the FPGA 200 and the FPGA 300 after having performed a speed conversion of the monitoring data DT_MNT, the monitoring data checker 600 having received the monitoring data DT_MNT performs the monitoring processing in the same way as the above-mentioned embodiment [1].

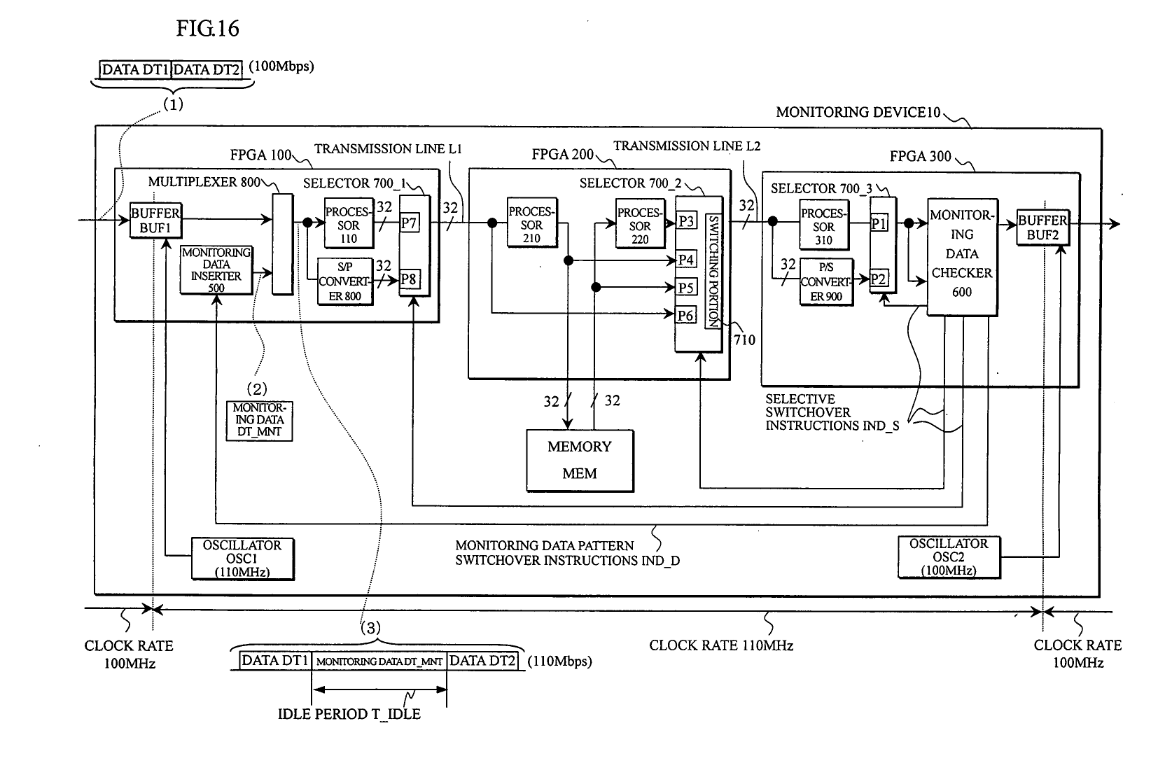

### ⊚Embodiment [3]: FIG. 16

The monitoring device 10 shown in FIG. 16 is provided with, in addition to the arrangement described in the above-mentioned embodiment [2], an oscillator OSC1 for providing a clock rate higher than that of the data DT and an oscillator OSC2 for providing the original clock rate of the data DT on the output side of this monitoring device 10. Also, the FGPA 300 is provided with a buffer BUF2 connected to the oscillator OSC2 and the monitoring data checker 600.

As shown in a portion (1) of FIG. 16, when the data DT1 and DT2 are inputted to the FPGA 100 at e.g. 100 MHz of clock rate with no gap (the maximum transmission rate), these data DT1 and DT2 are stored in the buffer BUF1. It is supposed that the data DT1 and DT2 are not the Ethernet frames and do not have IFG between the data DT1 and the data DT2.

Since e.g. 110 MHz of clock rate is provided to the buffer BUF1 from the oscillator OSC1, the multiplexer 800, as shown in a portion (3) of FIG. 16, multiplexes the data DT1, DT2 and the monitoring data DT_MNT with a redundant bandwidth of 10 Mbps (110 Mbps-100 Mbps) generated by this clock rate change being made the idle period T_IDLE.

Thus, even in such a case that the data, which are not the Ethernet frames and do not have IFG or the like therebetween, is inputted at the maximum transmission rate, the monitoring data DT_MNT can be respectively provided to the processor 110 within the FPGA 100, the processors 210 and 220 within the FPGA 200, the processor 310 within the FPGA 300, the transmission line L1 between the FPGA 100 and the FPGA 200, and the transmission line L2 between the FPGA 200 and the FPGA 300 after having performed a speed conversion of the monitoring data DT_MNT. Therefore, the monitoring data checker 600 having received the monitoring data DT_MNT can perform the monitoring processing in the same way as the above-mentioned embodiments [1] and [2].

Also, in the monitoring data checker 600, the normal data DT1 and DT2 having been determined not as the monitoring data DT_MNT are once stored in the buffer BUF2. Since the 100 MHz of clock rate is provided to the buffer BUF2 from the oscillator OSC2, the data DT1 and DT2 read out of the buffer BUF2 are transmitted to the subsequent stages at the original clock rate 100 MHz.

Thus, the redundant bandwidth generated as the idle period T_IDLE are deleted, so that control of a device such as the switching equipment at the subsequent stages is not affected in any way.

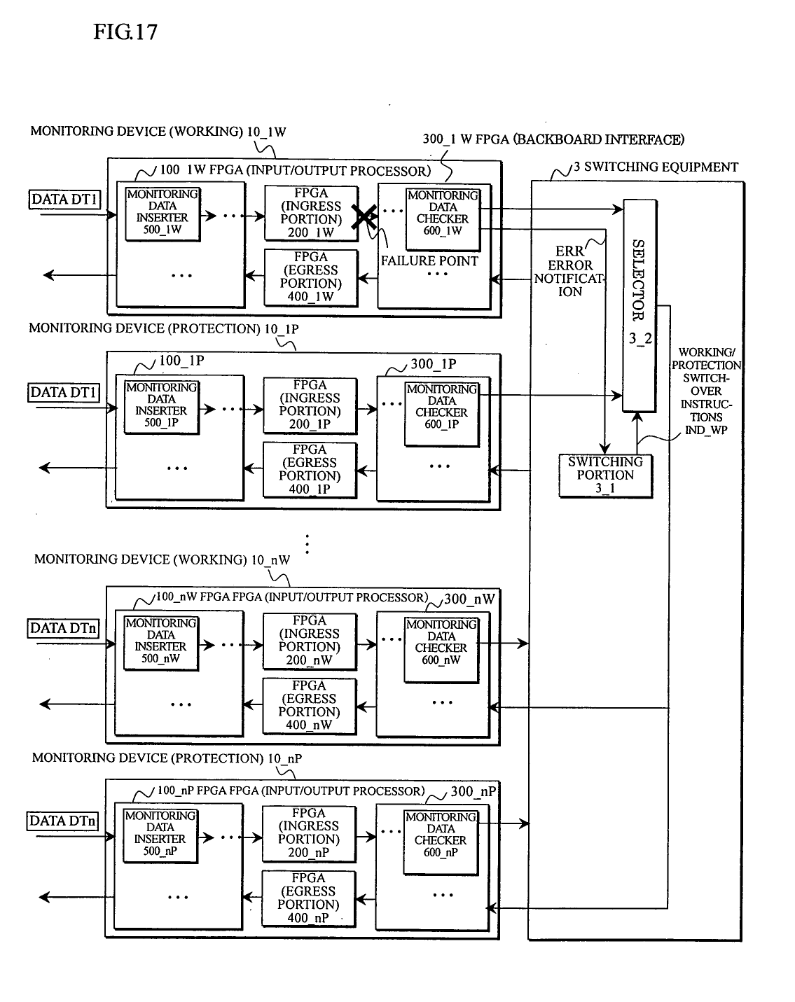

### ⊚Embodiment [4]: FIG. 17

The monitoring system shown in FIG. 17 is provided with monitoring devices 10_1W-10_{—}nW as a working system and monitoring devices 10_1P-10_{—}nP as a protection system. The monitoring devices 10_1W-10_{—}nW and the monitoring devices 10_1P-10_{—}nP are connected to e.g. the switching equipment 3 in common.

Also, the monitoring devices 10_1W-10_{—}nW and the monitoring devices 10_1P-10_{—}nP, in the same way as the above-mentioned embodiments [1]-[3], are respectively provided with FPGAs 100_1W-100_{—}nW and 100_1P-100_{—}nP as the input/output processors provided with monitoring data inserters 500_1W-500_{—}nW and 500_1P-500_{—}nP, FPGAs 200_1W-200_{—}nW and 200_1P-200_{—}nP as the ingress portions, FPGAs 300_1W-300_{—}nW and 300_1P-300_{—}nP as the backboard interfaces provided with monitoring data checkers 600_1W-600_{—}nW and 600_1P-600_{—}nP, and FPGAs 400_1W-400_{—}nW and 400_1P-400_{—}nP as the egress portions. It is to be noted that in order to simplify FIG. 17, the selector 700 and the switching portion 710 or the like within the monitoring devices 10_1W-10_{—}nW and 10_1P-10_{—}nP are omitted or not shown.

For example, when the failure × has occurred in the FPGA or the transmission line between the FGPAs of the monitoring device 10_1W as the working system, the monitoring data checker 600_1W detects this failure in the same way as the above-mentioned embodiments [1]-[3]. At this time, the monitoring data checker 600_1W notifies an error notification ERR indicating that the failure has occurred to the switching equipment 3, different from the above-mentioned embodiments [1]-[3].

A switching portion 3_1 within the switching equipment 3 having received the error notification ERR provides working/protection switchover instructions IND_WP for switching over from the monitoring device 10_1W to the monitoring device 10_1P of the protection system to a selector 3_2. The selector 3_2 having received the working/protection switchover instructions IND_WP performs the switchover so as to provide the data D1 outputted from the monitoring device 10_1P to other monitoring devices 10_2W-10_{—}nW and 10_2P-10_{—}nP.

It is to be noted that the present invention is not limited by the above-mentioned embodiments, and it is obvious that various modifications may be made by one skilled in the art based on the recitation of the claims.

What is claimed is:

1. A monitoring device comprising:
a first means inserting monitoring data of a predetermined pattern into an idle period of input data to be transmitted to a transmission line;
a second means selecting one or more processors arranged in the transmission line to make the selected processors process the monitoring data from the transmission line or diverting the monitoring data from all processors arranged in the transmission line; and
a third means determining whether or not the monitoring data outputted from the selected processors through the transmission line maintains the predetermined pattern by comparing the monitoring data with the predetermined pattern prestored, and detecting a failure point in the processors by controlling the second means to sequentially perform a selective switchover to the processors when determining that the predetermined pattern is not maintained.

2. The monitoring device as claimed in claim 1, further comprising a fourth means switching over channels composing the transmission line at an output side of the processors,
the third means including a means controlling the fourth means to detect which channel of an input side transmission line or output side transmission line of the processors has caused a failure when the failure point in the processors can not be detected.

3. The monitoring device as claimed in claim 1, further comprising a fourth means selectively providing the monitoring data to one or more second or third processors respectively arranged in an input side transmission line or output side transmission line of the processors to be processed,
the third means detecting a failure point in the second or third processors by controlling the fourth means to sequentially perform the selective switchover to the second or third processors.

4. The monitoring device as claimed in claim 1, wherein the third means includes a means providing pattern switchover instructions of the monitoring data to the first means in order for the processors not to treat the monitoring data as invalid data.

5. The monitoring device as claimed in claim 1, wherein the third means controls the second means only when determining equal to or more than a predetermined number of times that the monitoring data does not maintain the predetermined pattern.

6. The monitoring device as claimed in claim 1, wherein the third means includes a means controlling the second means to detect the failure point in the processors and to reconfigure the processors in which the failure point has been detected only when determining equal to or more than a predetermined number of times that the monitoring data does not maintain the predetermined pattern.

7. The monitoring device as claimed in claim 1, wherein the input data comprises an Ethernet frame,
the monitoring device further comprising a fourth means storing the Ethernet frame in a buffer, and a fifth means reading equal to or more than a predetermined number of Ethernet frames all at one time out of the buffer and generating the idle period by a summation of inter-frame gaps between the Ethernet frames read.

8. The monitoring device as claimed in claim 1, further comprising a fourth means storing the input data in a buffer, and a fifth means providing a clock rate higher than that of the input data to the buffer, reading the input data out of the buffer, and generating the idle period by a difference between both clock rates.

9. A monitoring system comprising:
a plurality of monitoring devices, as a working system and a protection system respectively,
the each monitoring device having a first means inserting monitoring data of a predetermined pattern into an idle period of input data to be transmitted to a transmission line, a second means selecting one or more processors arranged in the transmission line to make the selected processors process the monitoring data from the transmission line or diverting the monitoring data from all processors arranged in the transmission line, and a third means determining whether or not the monitoring data outputted from the selected processors through the transmission line maintains the predetermined pattern by comparing the monitoring data with the predetermined pattern prestored, and detecting a failure point in the processors by controlling the second means to sequentially perform a selective switchover to the processors when determining that the predetermined pattern is not maintained;
wherein the third means of the monitoring devices being provided with a means notifying an error outward when determining that the monitoring data does not maintain the predetermined pattern.

10. A monitoring method comprising:
a first step of inserting monitoring data of a predetermined pattern into an idle period of input data to be transmitted to a transmission line;
a second step of selecting one or more processors arranged in the transmission line to make the selected processors process the monitoring data from the transmission line or diverting the monitoring data from all processors arranged in the transmission line; and
a third step of determining whether or not the monitoring data outputted from the selected processors through the transmission line maintains the predetermined pattern by comparing the monitoring data with the predetermined pattern prestored, and detecting a failure point in the processors by controlling the second step to sequentially perform a selective switchover to the processors when determining that the predetermined pattern is not maintained.
